(19) United States
(12) Patent Application Publication
(10) Pub. No.: US 2016/0289388 A1
(43) Pub. Date: Oct. 6, 2016

(54) Silicate Resins And Methods Of Preparing Same

(71) Applicant: Dow Corning Corporation, Midland, MI (US)

(72) Inventors: Peng-Fei Fu, Midland, MI (US); Eric Moyer, Midland, MI (US)

(21) Appl. No.: 15/037,138

(22) PCT Filed: Dec. 11, 2014
(86) PCT No.: PCT/US2014/067262

§ 371 Date: May 17, 2016

Related U.S. Application Data
(60) Provisional application No. 61/920,392, filed on Dec. 23, 2013.

(51) Int. Cl. C08G 77/08; C08G 77/20; C08G 77/14; C08G 77/28; C08G 77/24; C08G 77/38; C08G 77/26

(52) U.S. Cl. CPC C08G 77/08; C08G 77/38; C08G 77/20; C08G 77/26; C08G 77/28; C08G 77/24; C08G 77/14

(57) ABSTRACT

Provided in various embodiments are methods for making functional silicate MT′Q, MD′Q, and MM′Q resin compositions and the functional silicate resin compositions prepared by such methods. The functional silicate resin compositions may be used in, for example, coatings, rubbers, sealants, antifoams, paints, electronics, personal care items, medical devices and the like.

### CROSS-REFERENCE TO RELATED APPLICATIONS

This application claims the benefit of U.S. Provisional Patent Application Ser. No. 61/920,392, filed on 23 Dec. 2013, under 35 U.S.C. §119(e). U.S. Provisional Patent Application Ser. No. 61/920,392 is hereby incorporated by reference.

### BRIEF SUMMARY OF THE INVENTION

This disclosure relates generally to new synthetic methods for making functional silicate resin compositions and the functional silicate resin compositions prepared by such methods. More specifically, this disclosure relates to synthetic methods for making functional silicate MT′Q, MD′Q, and MM′Q resin compositions and the functional silicate resin compositions prepared by such methods. The functional silicate resin compositions may be used in, for example, coatings, rubbers, sealants, antifoams, paints, electronics, personal care items, medical devices and the like.

### BRIEF DESCRIPTION OF THE DRAWINGS

The foregoing and other advantages of the invention will become apparent upon reading the following detailed description and upon reference to the drawings.

FIGS. 1-2 are ²⁹Si-NMR spectra (in CDCl₃) of illustrative functional silicate resins formed using methods of the invention.

While the invention is susceptible to various modifications and alternative forms, specific embodiments have been shown by way of example in the drawings and will be described in detail herein. It should be understood that the invention is not intended to be limited to the particular forms disclosed. Rather, the invention is to cover all modifications, equivalents, and alternatives falling within the spirit and scope of the invention.

### DETAILED DESCRIPTION OF THE INVENTION

The present disclosure generally provides functional silicate resin compositions and methods of making such functional silicate resin compositions. The functional silicate resin compositions of the present disclosure can be used in, by way of example, coatings, rubbers, sealants, antifoams, paints, electronics, personal care items, medical devices and the like.

Synthesis of Functional MT′Q Resins

One aspect of the invention relates to a method of preparing a functional silicate resin composition comprising reacting (a) an MQ resin with (b) a trifunctional silane of the formula RSi(OR′)₃ in the presence of (c) a catalytic amount of a base to form an MT′Q resin having a general formula:

((CH₃)₃SiO_{1/2})ₘ(RSiO_{3/2})ₙ(SiO_{4/2})ₒ Formula (1)

wherein R is an organic functional group comprising an epoxy group, an acrylate group, a thiol group, an alkenyl group, a vinyl ether group, an amino group, a fluoro group, or any combination(s) thereof; R′ is a hydrogen atom or a hydrocarbon group having 1 to 4 carbon atoms; and m, n, o is the molar percent of each resin unit in the resin, m+n+o=1; and (d) optionally, an organic solvent. In some embodiments, the reaction is conducted at temperature ranging from about 23° C. to about 150° C. In further embodiments, the temperature ranges from about 23° C. to about 120° C. In still further embodiments, the temperature ranges from about 50° C. to about 80° C.

The acronym MQ as it relates to silicone resins is derived from the symbols M, D, T, and Q each of which represent a functionality of different types of structural units which may be present in silicone resins containing siloxane units joined by Si—O—Si bonds. Monofunctional (M) unit represents (CH₃)₃SiO_{1/2}. Difunctional (D) unit represents (CH₃)₂SiO_{2/2}. Trifunctional (T) unit represents CH₃SiO_{3/2} and results in the formation of branched linear siloxanes. Tetrafunctional (Q) unit represents SiO_{4/2} which results in the formation of resinous silicone compositions.

Using the methods detailed herein, a functional silicate resin is formed which has the general formula:

((CH₃)₃SiO_{1/2})ₘ(RSiO_{3/2})ₙ(SiO_{4/2})ₒ Formula (1)

wherein R is an organic functional group comprising an epoxy group, an acrylate group, a thiol group, an alkenyl group, a vinyl ether group, an amino group, a fluoro group, or any combination(s) thereof, and m, n, o is the molar percent of each resin unit in the resin, m+n+o=1. In one embodiment, the functional silicate resin is

((CH₃)₃SiO_{1/2})ₘ[(R¹SiO_{3/2})ₓ(R²SiO_{3/2})_{y}]ₙ(SiO_{4/2})ₒ Formula (2)

wherein R¹ and R² are each independently an epoxy group, an acrylate group, an alkenyl group, a thiol group, a vinyl ether group, or any combination(s) thereof; m, n, o is the molar percent of each resin unit in the resin, m+n+o=1; and x+y=n.

Synthesis of Functional MD′Q Resins

A further aspect of the invention relates to a method of preparing a functional silicate resin composition comprising reacting (a) an MQ resin with (b) a difunctional silane of the formula RR″Si(OR′)₂ in the presence of (c) a catalytic amount of a base to form an MD′Q resin having a general formula:

((CH₃)₃SiO_{1/2})ₘ(RR″SiO_{2/2})ₙ(SiO_{4/2})ₒ Formula (3)

wherein R is an organic functional group comprising an epoxy group, an acrylate group, a thiol group, an alkenyl group, a vinyl ether group, an amino group, a fluoro group, or any combination(s) thereof; R′ is a hydrogen atom or a hydrocarbon group having 1 to 4 carbon atoms, R″ is an alkyl or aryl group having 1-20 carbon atoms; and m, n, o is the molar percent of each resin unit in the resin, m+n+o=1; and (d) optionally, an organic solvent. In some embodiments, the reaction is conducted at temperature ranging from about 23° C. to about 150° C. In further embodiments, the temperature ranges from about 23° C. to about 120° C. In still further embodiments, the temperature ranges from about 50° C. to about 80° C.

Using the methods detailed herein, a functional silicate resin is formed which has the general formula:

((CH₃)₃SiO_{1/2})ₘ(RR″SiO_{2/2})ₙ(SiO_{4/2})ₒ Formula (3)

wherein R is an organic functional group comprising an epoxy group, an acrylate group, a thiol group, an alkenyl group, a vinyl ether group, an amino group, a fluoro group, or any combination(s) thereof; R″ is an alkyl or aryl group having 1-20 carbon atoms; and m, n, o is the molar percent of each resin unit in the resin, m+n+o=1.

Synthesis of Functional MM′Q Resins

A still further aspect of the invention relates to a method of preparing a functional silicate resin composition comprising reacting (a) an MQ resin with (b) a monofunctional silane of the formula RR″₂Si(OR′) in the presence of (c) a catalytic amount of a base to form an MM′Q resin having a general formula:

((CH₃)₃SiO_{1/2})ₘ(RR″₂SiO_{1/2})ₙ(SiO_{4/2})ₒ Formula (4)

wherein R is an organic functional group comprising an epoxy group, an acrylate group, a thiol group, an alkenyl group, a vinyl ether group, an amino group, a fluoro group, or any combination(s) thereof; R′ is a hydrogen atom or a hydrocarbon group having 1 to 4 carbon atoms; each R″ is independently an alkyl or aryl group having 1-20 carbon atoms; and m, n, o is the molar percent of each resin unit in the resin, m+n+o=1; and (d) optionally, an organic solvent. In some embodiments, the reaction is conducted at temperature ranging from about 23° C. to about 150° C. In further embodiments, the temperature ranges from about 23° C. to about 120° C. In still further embodiments, the temperature ranges from about 50° C. to about 80° C.

Using the methods detailed herein, a functional silicate resin is formed which has the general formula:

((CH₃)₃SiO_{1/2})ₘ(RR″₂SiO_{1/2})ₙ(SiO_{4/2})ₒ Formula (4)

wherein R is an organic functional group comprising an epoxy group, an acrylate group, a thiol group, an alkenyl group, a vinyl ether group, an amino group, a fluoro group, or any combination(s) thereof; each R″ is independently an alkyl or aryl group having 1-20 carbon atoms; and m, n, o is the molar percent of each resin unit in the resin, m+n+o=1.

MQ Resin Component

The MQ resin used in preparing the functional silicate resin compositions detailed herein has the formula:

((CH₃)₃SiO_{1/2})ₘ(SiO_{4/2})ₒ Formula (5)

wherein m, o is the molar percent of each resin unit in the resin, m+o=1, and the molar ratio of m/o is in the range of from about 0.1/1 to about 2/1. In further embodiments, the molar ratio of m/o is in the range of from about 0.2/1 to about 1/1. Nonlimiting examples of suitable commercially available versions of the MQ resin are as described in U.S. Pat. No. 2,676,182 to Daudt et al. and Frey, C. L. J. Org. Chem. 1970, 35, 1308.

The MQ resins contemplated for use in forming the functional silicate resin compositions can be made via the polymerization of acidified aqueous silicate followed by capping with Me₃Si— or by methods known in the art for forming MQ resins.

Base Component

The base used in preparing the functional silicate resin compositions detailed herein is an inorganic base, an organic base, or a mixture of inorganic and organic bases. The base used in preparing the functional silicate resin compositions detailed herein may include, but is not limited to, potassium hydroxide, sodium hydroxide, cesium hydroxide, potassium methoxide, sodium methoxide, cesium methoxide, tetramethylammonium hydroxide, pyridine, methyl amine, imidazole, benzimidazole, histidine, phosphazene, or any combination(s) thereof. The base may be selected, by way of example, based on basicity and solubility of the base in the solvent.

In some embodiments, the amount of base in the functional silicate resin ranges from about 0.01 wt. % to about 1 wt. %. In further embodiments, the amount of base in the functional silicate resin ranges from about 0.05 wt. % to about 0.8 wt. %. In further embodiments, the amount of base in the functional silicate resin ranges from about 0.1 wt. % to about 0.5 wt. %.

Optional Organic Solvent Component

An organic solvent may be present in preparing the functional silicate resin compositions detailed herein to increase the homogeneity of the reaction mixture. The organic solvent may include, but is not limited to, toluene, xylene, propylene glycol monomethyl ether acetate, 2-butanone, ethyl acetate, butyl acetate, acetonitrile, benzene, cyclohexane, dioxane, diethyl ether, tetrahydrofuran, hexane, or any combination(s) thereof.

Where an organic solvent is used to prepare the functional silicate resin compositions detailed herein, the amount of organic solvent in the functional silicate resin ranges from about 70 wt. % to about 95 wt. %, In further embodiments, the amount of organic solvent in the functional silicate resin ranges from about 20 wt. % to about 60 wt. %. It is contemplated that the base can be dissolved in the functional silane or used as a suspension.

Silane Component where R is an Epoxy Group

According to one aspect, R is independently an epoxy group. Where R is an epoxy group, the epoxy functional group is an organic group containing an epoxy ring. Examples of suitable epoxy functional groups for use in making the functional silicate resin compositions include, but are not limited to, 3-glycidoxypropyl groups and 2-(3,4-epoxycyclohexyl)ethyl groups, or any combination(s) thereof. The epoxy functional silanes used for the reaction may include

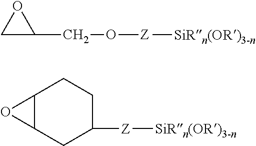

wherein Z is a hydrocarbon chain, including but not limited to, —CH₂—, —(CH₂)₂—, (CH₂)₃—, —(CHMe-CH₂CH₂)—, and —(CH₂)₄—; n=0, 1, or 2; R′ is a hydrogen atom or a hydrocarbon group having 1 to 4 carbon atoms; and each R″ is independently an alkyl or aryl group having 1-20 carbon atoms. More specifically, examples of suitable epoxy functional silanes used for the reaction may include, but are not limited to, (3-glycidoxypropyl) trimethoxysilane (EpSi(OMe)₃), (3-glycidoxypropyl) dimethoxymethylsilane (EpSiMe(OMe)₂), 2-(3,4-epoxycyclohexyl)ethyl trim ethoxysilane (CHEpSi(OMe)₃), 2-(3,4-epoxycyclohexyl)ethyl dimethoxymethyl silane (CHEpSiMe(OMe)₂), or any combination(s) thereof. The epoxy functional silanes contemplated for use in forming the functional silicate resin compositions can be made via methods known in the art for forming epoxy functional silanes and are also commercially available.

Silane Component where R is an Acrylate Group

According to one aspect, R is independently an acrylate group. Where R is an acrylate group, the acrylate functional group contains the structural unit CH₂═CHR³—COO—, wherein R³ is hydrogen, an alkyl group, or an aryl group. The acrylate functional silanes used for the reaction may also include

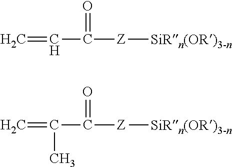

wherein Z is a hydrocarbon chain, including but not limited to, —CH₂—, —(CH₂)₂—, (CH₂)₃—, —(CHMe-CH₂CH₂)—, and —(CH₂)₄—; n=0, 1, or 2; R′ is a hydrogen atom or a hydrocarbon group having 1 to 4 carbon atoms; and each R″ is independently an alkyl or aryl group having 1-20 carbon atoms. Examples of suitable acrylate functional silanes for use in making the functional silicate resin compositions include, but are not limited to, (3-acryloxypropyl)trimethoxysilane, methacryloxypropyltrimethoxysilane, methacryloxymethyltrimethoxysilane, or any combination(s) thereof. The acrylate functional silanes contemplated for use in forming the functional silicate resin compositions can be made via methods known in the art for forming acrylate functional silanes and are also commercially available.

Silane Component where R is a Thiol Group

According to one aspect, R is independently a thiol group. One nonlimiting example of a suitable thiol functional silane for use in making the functional silicate resin compositions is

HS—Z—SiR″ₙ(OR′)₃₋ₙ Formula (6)

wherein Z is a hydrocarbon chain, including but not limited to, —CH₂—, —(CH₂)₂—, (CH₂)₃—, —(CHMe-CH₂CH₂)—, and —(CH₂)₄—; n=0, 1, or 2; R′ is a hydrogen atom or a hydrocarbon group having 1 to 4 carbon atoms; and each R″ is independently an alkyl or aryl group having 1-20 carbon atoms. Further examples of suitable thio-functional silanes for use in making the functional silicate resin compositions include, but are not limited to, thiopropyl trimethoxysilane, thioethyl trimethoxysilane, thiobutyl trimethoxysilane, or any combination(s) thereof. The thio-functional silanes contemplated for use in forming the functional silicate resin compositions can be made via methods known in the art for forming thio-functional silanes and are also commercially available.

Silane Component where R is an Alkenyl Group

According to one aspect, R is independently an alkenyl group. One nonlimiting example of a suitable alkenyl containing silane for use in making the functional silicate resin compositions is

H₂C═CH—Z—SiR″ₙ(OR′)₃₋ₙ Formula (7)

wherein Z is a hydrocarbon chain, including but not limited to, —CH₂—, —(CH₂)₂—, (CH₂)₃—, —(CHMe-CH₂CH₂)—, and —(CH₂)₄—; n=0, 1, or 2; R′ is a hydrogen atom or a hydrocarbon group having 1 to 4 carbon atoms; and each R″ is independently an alkyl or aryl group having 1-20 carbon atoms. Further examples of suitable alkenyl groups for use in making the functional silicate resin compositions include, but are not limited to, H₂C═CH—, H₂C═CHCH₂—, H₂C═C(CH₃)CH₂—, H₂C═CHCH₂CH₂—, H₂C═CHCH₂CH₂CH₂—, H₂C═CHCH₂CH₂CH₂CH₂—, or any combination(s) thereof. The alkenyl functional silanes contemplated for use in forming the functional silicate resin compositions can be made via methods known in the art for forming alkenyl functional silanes and are also commercially available.

Silane Component where R is a Vinyl Ether Group

According to one aspect, R is independently a vinyl ether group. One nonlimiting example of a suitable vinyl ether group for use in making the functional silicate resin compositions is

H₂C═C—O—Z—SiR″ₙ(OR′)₃₋ₙ Formula (8)

wherein Z is a hydrocarbon chain, including but not limiting, —CH₂—, —(CH₂)₂—, (CH₂)₃—, —(CHMe-CH₂CH₂)—, and —(CH₂)₄—; n=0, 1, or 2; R′ is a hydrogen atom or a hydrocarbon group having 1 to 4 carbon atoms; and each R″ is independently an alkyl or aryl group having 1-20 carbon atoms. The vinyl ether functional silanes contemplated for use in forming the functional silicate resin compositions can be made via methods known in the art for forming vinyl ether functional silanes and are also commercially available.

Silane Component where R is an Amino Group

According to one aspect, R is independently an amino group. Where R is an amino group, the amino functional group is an organic group containing the structural unit R³N—, wherein R³ is hydrogen, an alkyl group, or an aryl group. One nonlimiting example of a suitable amino containing silane for use in making the functional silicate resin compositions is

R³₃N—Z—SiR″ₙ(OR′)₃₋ₙ Formula(9)

wherein Z is a hydrocarbon chain, including but not limiting, —CH₂—, —(CH₂)₂—, (CH₂)₃—, —(CHMe-CH₂CH₂)—, and —(CH₂)₄—; n=0, 1, or 2; R′ is a hydrogen atom or a hydrocarbon group having 1 to 4 carbon atoms; each R″ is independently an alkyl or aryl group having 1-20 carbon atoms; and R³ is hydrogen, an alkyl group, or an aryl group. The amino functional silanes contemplated for use in forming the functional silicate resin compositions can be made via methods known in the art for forming amino functional silanes and are also commercially available.

Silane Component where R is a Fluoro Group

According to one aspect, R is independently a fluoro group. One nonlimiting example of a suitable fluoro group for use in making the functional silicate resin compositions is

CF₃—(CF₂)ₘ—Z—SiR″ₙ(OR′)₃₋ₙ Formula (10)

wherein Z is a hydrocarbon chain, including but not limiting, —CH₂—, —(CH₂)₂—, (CH₂)₃—, —(CHMe-CH₂CH₂)—, and —(CH₂)₄—; n=0, 1, or 2; R′ is a hydrogen atom or a hydrocarbon group having 1 to 4 carbon atoms; and each R″ is independently an alkyl or aryl group having 1-20 carbon atoms; and m≧0. The fluoro functional silanes contemplated for use in forming the functional silicate resin compositions can be made via methods known in the art for forming fluoro functional silanes and are also commercially available.

Resulting Functional Silicate Resin Compositions

The functional silicate resin compositions may optionally be mixed with one or more silanes, siloxane polymers, fillers, solvents, and catalysts to form the final functional silicate resin composition formulations for use in applications such as coatings, rubbers, sealants, antifoams, paints, electronics, personal care items, medical devices and the like. The functional silicate resin compositions can be used in applications that require tough, water resistant, solvent resistant, scratch resistant, and heat resistant materials.

While the invention is susceptible to various modifications and alternative forms, specific embodiments are described by way of example herein, and the invention is not intended to be limited to the particular forms disclosed. Rather, the invention is intended to cover all modifications, equivalents, and alternatives falling within the spirit and scope of the invention.

### EXAMPLES

These examples are intended to illustrate the invention to one of ordinary skill in the art and should not be interpreted as limiting the scope of the invention set forth in the claims. All parts and percentages in the examples are on a weight basis and all measurements were indicated at about 23° C. (room temperature), unless indicated to the contrary.

### Example 1

### Synthesis of Epoxy MT′Q Resin: M_{0.31} T^{Ep}_{0.17}Q_{0.52}

To a 3 L flask equipped with a magnetic stir-bar was added 800 g of toluene, followed by 500 g of an MQ resin powder with a structure of M_{0.43}Q_{0.57} as identified by ²⁹Si-NMR. 325 g of (3-glycidoxypropyl)trimethoxysilane and 0.82 g of KOH were then added to the flask. The mixture was stirred at 100° C. under nitrogen, and the reaction progress was monitored by gas chromatography (GC). After five hours, the reaction mixture was cooled to 50° C. 4.1 g of acetic acid was then added to the flask. The mixture was stirred for 1 hour while cooling to room temperature. The solution was then filtered through a 1 micron filter to a clear and viscous liquid. Upon the removal of volatiles by a roto-vap, a clear liquid resin was obtained (650 g).

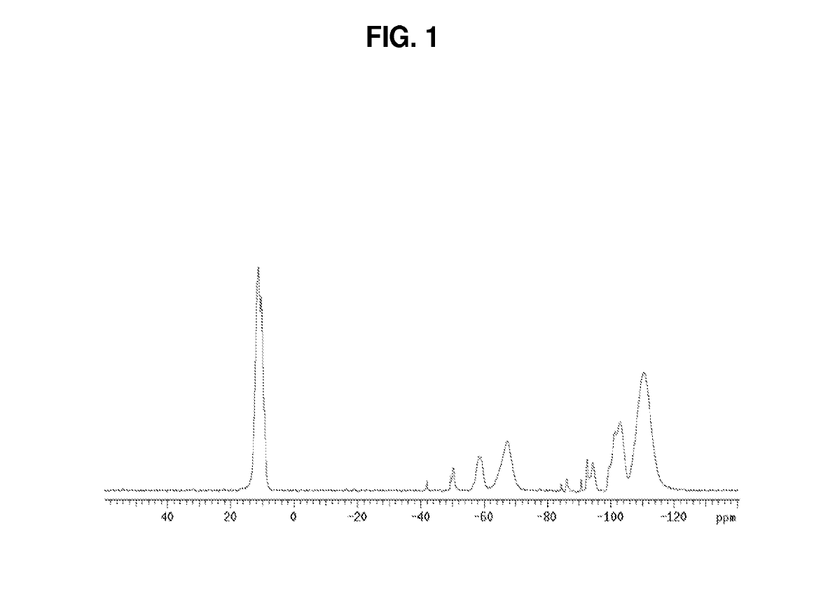

The resulting epoxy functional silicate MT′Q resin was characterized as follows: viscosity: 17,000 cP; GPC: Mw=3,800, PDI=1.59; composition by ²⁹Si-NMR (shown in FIG. 1): M_{0.31}T^{Ep}_{0.17}Q_{0.52}. ¹³C-NMR showed the epoxy ring as intact and that an epoxy MT′Q resin was formed: M^{0.31}T^{Ep}_{0.17}Q_{0.52}.

### Example 2

### Synthesis of Epoxy MT′Q Resin: M_{0.31} T^{CHEp}_{0.17}Q_{0.52}

To a 3 L flask equipped with a magnetic stir-bar was added 800 g of toluene, followed by 500 g of an MQ resin powder with a structure of M_{0.43}Q_{0.57} by ²⁹Si-NMR. 337 g of 2-(3,4-epoxycyclohexyl)ethyl trimethoxysilane and 0.82 g of KOH were then added to the flask. The mixture was stirred at 100° C. under nitrogen, and the reaction progress was monitored by GC. After five hours, the reaction mixture was cooled to 50° C. 4.1 g of acetic acid was then added to the flask. The mixture was stirred for 1 hour while cooling to room temperature. The solution was then filtered through a 1 micron filter to give a clear and viscous liquid. Upon the removal of volatiles by a roto-vap, a clear liquid resin was obtained (790 g).

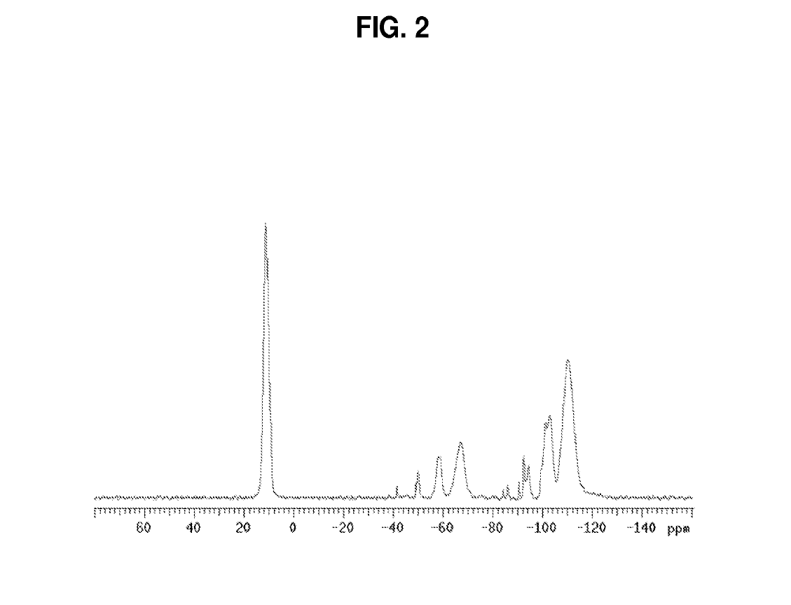

The resulting epoxy functional silicate MT′Q resin was characterized as follows: viscosity: 60,000 cP; GPC: Mw=2,610, PDI=1.41; composition by ²⁹Si-NMR (shown in FIG. 2): M_{0.31} T^{CHEp}_{0.17}Q_{0.52}. ¹³C-NMR showed the epoxy ring as intact and that an epoxy MT′Q resin was formed: M_{0.31}T^{CHEp}_{0.17}Q_{0.52}.

### Example 3

### Synthesis of Epoxy MD′Q Resin: M_{0.36}D^{Ep}_{0.13}Q_{0.51}

To a 100 mL flask equipped with a magnetic stir-bar was added 25 g of toluene, followed by 14.7 g of an MQ resin powder with a structure of M_{0.43}Q_{0.57} by ²⁹Si-NMR. 8.8 g of (3-glycidoxypropyl) methyldimethoxysilane and 0.16 g of KOH were then added to the flask. The mixture was stirred at 100° C. under nitrogen, and the reaction progress was monitored by GC. After eight hours, the reaction mixture was cooled to 50° C. 0.2 g of acetic acid was then added to the flask. The mixture was stirred for 1 hour while cooling to room temperature. The solution was then filtered through a 1 micron filter to give a clear and viscous liquid. Upon the removal of volatiles by a roto-vap, a clear liquid resin was obtained (790 g).

The resulting epoxy functional silicate MD′Q resin was characterized as follows: viscosity: 7,000 cP; GPC: Mw=2,700, PDI=1.74; composition by ²⁹Si-NMR: M_{0.36}D^{Ep}_{0.13}Q_{0.51}. ¹³C-NMR showed the epoxy ring was intact and that an epoxy MT′Q resin was formed: M_{0.36}D^{Ep}_{0.13}Q_{0.51}.

### Example 4

### Synthesis of Epoxy MM′Q Resin: M_{0.38}M^{Ep}_{0.15}Q_{0.51}

To a 100 mL flask equipped with a magnetic stir-bar was added 25 g of toluene, followed by 14.7 g of an MQ resin powder with a structure of M_{0.43}Q_{0.57} by ²⁹Si-NMR. 8.7 g of (3-glycidoxypropyl) dimethylmethoxysilane and 0.16 g of KOH were then added to the flask. The mixture was stirred at 100° C. under nitrogen, and the reaction progress was monitored by GC. After 40 hours, the reaction mixture was cooled to 50° C. 0.2 g of acetic acid was then added to the flask. The mixture was stirred for 1 hour while cooling to room temperature. The solution was then filtered through a 1 micron filter to give a clear and viscous liquid. Upon the removal of volatiles by a roto-vap, a clear solid resin was obtained.

The resulting epoxy functional silicate resin was characterized as follows: viscosity: 3,000 cP; GPC: Mw=4,330, PDI=1.46; composition by ²⁹Si-NMR: M_{0.38}M^{Ep}_{0.15}Q_{0.51}. ¹³C-NMR showed the epoxy ring as intact and that an epoxy MT′Q resin was formed: M_{0.38}M^{Ep}_{0.15}Q_{0.51}.

### Summary of Examples 1-4

A summary of the results of the epoxy functional silicate resin compositions formed in Examples 1-4 is set forth in Table A:

TABLE A
Summary of MT'Q Resins Formed Via the Reaction
of MQ Resin with X-Si(OR)₃

| | | | Vis- | | |
|---|---|---|---|---|---|
| Exam- | | | cosity | | |
| ple | Epoxysilane | Resin Structure | (cP) | Mw | PDI |
| 1 | EpSi(OMe)₃ | M_{0.31}T^{Ep}_{0.17}Q_{0.52} | 17,000 | 3,800 | 1.59 |
| 2 | CHEp-Si(OMe)₃ | M_{0.31}T^{CHEp}_{0.17}Q_{0.52} | 60,000 | 2,610 | 1.41 |
| 3 | EpSiMe(OMe)₂ | M_{0.36}D^{Ep}_{0.13}Q_{0.51} | 7,000 | 2,700 | 1.74 |
| 4 | EpSiMe₂(OMe) | M_{0.38}M^{Ep}_{0.15}Q_{0.51} | 3,000 | 4,330 | 1.46 |

### Example 5

### Synthesis of Methacrylate Functional MT′Q Resin: M_{0.33}T^{MA}_{0.16}Q_{0.52}

To a 3 L flask equipped with a magnetic stir-bar was added 800 g of toluene, followed by 500 g of an MQ resin powder with a structure of M_{0.43}Q_{0.57} by ²⁹Si-NMR. 340 g of methacryloxypropyl trimethoxysilane and 0.82 g of KOH were then added to the flask. The mixture was stirred at 100° C. under nitrogen, and the reaction progress was monitored by GC. After four hours, the reaction mixture was cooled to 50° C. 4.1 g of acetic acid was then added to the flask. The mixture was stirred for 1 hour while cooling to room temperature. The solution was then filtered through a 1 micron filter to give a clear and viscous liquid. Upon the removal of volatiles by a roto-vap, a clear liquid resin was obtained (700 g). ¹³C-NMR shows the acrylate group is intact.

The resulting methacrylate functional silicate resin was characterized as follows: viscosity: 6,700 cP; GPC: Mw=4,030, PDI=1.63; composition by ²⁹Si-NMR: M_{0.33}T^{MA}_{0.16}Q_{0.52}.

### Example 6

### Synthesis of Vinyl Functional MT′Q Resin: M_{0.21} T^{Vi}_{0.27}Q_{0.52}

To a 250 mL flask equipped with a magnetic stir-bar was added 36.8 g of toluene, followed by 36.8 g of an MQ resin powder with a structure of M_{0.43}Q_{0.57} by ²⁹Si-NMR. 22.2 g of vinyltrimethoxysilane and 0.37 g of KOH were then added to the flask. The mixture was stirred at 100° C. under nitrogen, and the reaction progress was monitored by GC. After six hours, the reaction mixture was cooled to 50° C. 0.5 g of acetic acid was then added to the flask. The mixture was stirred for 1 hour while cooling to room temperature. The solution was then filtered through a 1 micron filter to give a clear and viscous liquid. Upon the removal of volatiles by a roto-vap, a white solid resin was obtained.

The resulting methacrylate functional silicate resin was characterized as follows: viscosity: solid; GPC: Mw=20,400, PDI=4.77; composition by ²⁹Si-NMR: M_{0.21}T^{Vi}_{0.27}Q_{0.52}.

### Example 7

### Synthesis of Vinyl/Epoxy MT′Q Resin: M_{0.22}T^{Vi/Ep}_{0.31}Q_{0.48}

To a 250 mL flask equipped with a magnetic stir-bar was added 36.8 g of toluene, followed by 36.8 g of an MQ resin powder with a structure of M_{0.43}Q_{0.57} by ²⁹Si-NMR. 11.1 g of vinyltrimethoxysilane, 17.7 g of (3-glycidoxypropyl) trimethoxysilane, and 0.37 g of KOH were then added to the flask. The mixture was stirred at 100° C. under nitrogen, and the reaction progress was monitored by GC. After six hours, the reaction mixture was cooled to 50° C. 0.5 g of acetic acid was then added to the flask. The mixture was stirred for 1 hour while cooling to room temperature. The solution was then filtered through 1 micron filter to give a clear and viscous liquid. Upon the removal of volatiles by a roto-vap, a viscous liquid resin was obtained.

The resulting vinyl/epoxy functional silicate resin was characterized as follows: viscosity: 13,400 cP; GPC: Mw=26,700, PDI=7.68; composition by ²⁹Si-NMR: M_{0.22}T^{Vi/Ep}_{0.31}Q_{0.48}.

### Example 8

### Synthesis of Amine Functional MT′Q Resin: M_{0.30}T^{NH2}_{0.17}Q_{0.53}

To a 250 mL flask equipped with a magnetic stir-bar was added 36.8 g of toluene, followed by 36.8 g of an MQ resin powder with a structure of M_{0.43}Q_{0.57} by ²⁹Si-NMR. 17.9 g of 3-aminopropyl trimethoxysilane and 0.37 g of KOH were then added to the flask. The mixture was stirred at 100° C. under nitrogen, and the reaction progress was monitored by GC. After six hours, the reaction mixture was cooled to room temperature. The solution was then filtered through a 1 micron filter to give a clear and viscous liquid. Upon the removal of volatiles by a roto-vap, a viscous liquid resin was obtained.

The resulting amine functional silicate resin was characterized as follows: viscosity: 12,800 cP; GPC: Mw=16,500, PDI=3.25; composition by ²⁹Si-NMR: M_{0.30}T^{NH2}_{0.17}Q_{0.53.}

### Example 9

### Synthesis of Thio-Functional MT′Q Resin: M_{0.30}T^{SH}_{0.18}Q_{0.52}

To a 250 mL flask equipped with a magnetic stir-bar was added 36.8 g of toluene, followed by 36.8 g of an MQ resin powder with a structure of M_{0.43}T^{OH}_{0.12}Q_{0.45} by ²⁹Si-NMR. 19.6 g of 3-mercaptopropyl trimethoxysilane and 0.37 g of KOH were then added to the flask. The mixture was stirred at 100° C. under nitrogen, and the reaction progress was monitored by GC. After six hours, the reaction mixture was cooled to 50° C. 1.0 g of acetic acid was then added to the flask. The mixture was stirred for 1 hour while cooling to room temperature. The solution was then filtered through a 1 micron filter to give a clear and viscous liquid. Upon the removal of volatiles by a roto-vap, a white solid resin was obtained.

The resulting thio-functional silicate resin was characterized as follows: viscosity: solid; GPC: Mw=7,200, PDI=2.30; composition by 29Si-NMR: M_{0.30}T^{SH}_{0.18}Q_{0.52}.

### Example 10

### Synthesis of Epoxy/Fluoro Functional MTQ Resin: M_{0.34}T^{CHEp/F}_{0.18}Q_{0.48}

To a 1 L flask equipped with a magnetic stir-bar was added 150 g of toluene, followed by 72.8 g of MQ resin powder with a structure of M_{0.43}Q_{0.57} by ²⁹Si-NMR. 49.3 g of 2-(3,4-epoxycyclohexyl)ethyl trimethoxysilane, 25.5 g of (tridecafluoro-1,1,2,2,-tetrahydrooctyl) triethoxysilane, CF₃(CF₂)₅(CH₂)₂Si(OEt)₃, and 0.6 g of NaOMe solution (25% in MeOH), were then added into the flask. The mixture was stirred at 100° C. under nitrogen, and the reaction progress was monitored by GC. After six hours, the reaction mixture was cooled to 50° C. 0.75 g of acetic acid was then added to the flask. The mixture was stirred for 1 hour while cooling to room temperature. The solution was then filtered through a 1 micron filter to give a clear and viscous liquid. Upon the removal of volatiles by a roto-vap, a viscous liquid resin was obtained.

The resulting epoxy functional silicate resin was characterized as follows: viscosity: 685 cP; GPC: Mw=3,850, PDI=1.60; composition by ²⁹Si-NMR: M_{0.34}T^{CHEp/F}_{0.18}Q_{0.48}.

### Summary of Examples 5-10

A summary of the results of the various functional silicate resin compositions formed in Examples 5-10 is set forth in Table B:

TABLE B
Summary of MT'Q Resins Formed Via the Reaction
of MQ Resin with R-Si(OR)₃

| Exam- | Functional | | Viscosity | | |
|---|---|---|---|---|---|
| ple | Group | MT*Q Resin Structure | (cP) | Mw | PDI |
| 5 | Meth- | M_{0.33}T^{MA}_{0.16}Q_{0.52} | 6,700 | 4,030 | 1.63 |
| | acrylate | | | | |
| 6 | Vinyl | M_{0.21}T^{Vi}_{0.27}Q_{0.52} | Solid | 20,400 | 4.77 |
| 7 | Vinyl/ | M_{0.22}T^{Vi/Ep}_{0.31}Q_{0.48} | 13,400 | 26,700 | 7.68 |
| | Epoxy | | | | |
| 8 | Amine | M_{0.30}T^{NH2}_{0.17}Q_{0.53} | 12,800 | 16,500 | 3.25 |
| 9 | Thio- | M_{0.30}T^{SH}_{0.18}Q_{0.52} | Solid | 7,200 | 2.30 |
| 10 | Epoxy/ | M_{0.34}T^{CHEp/F}_{0.18}Q_{0.48} | 685 | 3,850 | 1.60 |
| | Fluoro- | | | | |

While the invention is susceptible to various modifications and alternative forms, specific embodiments have been shown by way of example in the drawings and described in detail herein. It should be understood, however, that the invention is not intended to be limited to the particular forms disclosed. Rather, the invention is to cover all modifications, equivalents, and alternatives falling within the spirit and scope of the invention as defined by the appended claims.

1. A method of preparing a functional silicate resin comprising:
reacting (a) an MQ resin with (b) a trifunctional silane of the formula RSi(OR′)₃ in the presence of (c) a catalytic amount of a base to form an MT′Q resin having a general formula:
((CH₃)₃SiO_{1/2})ₘ(RSiO_{3/2})ₙ(SiO_{4/2})ₒ
and, optionally, (d) an organic solvent,
wherein R is an organic functional group comprising an epoxy group, an acrylate group, a thiol group, an alkenyl group, a vinyl ether group, an amino group, a fluoro group, or any combination thereof; R′ is a hydrogen atom or a hydrocarbon group having 1 to 4 carbon atoms; and m, n, o is the molar percent of each resin unit in the resin, m+n+o=1.

2. A method of preparing a functional silicate resin comprising:
reacting (a) an MQ resin with (b) a difunctional silane of the formula RR″Si(OR′)₂ in the presence of (c) a catalytic amount of a base to form an MD′Q resin having a general formula:
((CH₃)₃SiO_{1/2})ₘ(RR″SiO_{2/2})ₙ(SiO_{4/2})ₒ
and, optionally, (d) an organic solvent,
wherein R is an organic functional group comprising an epoxy group, an acrylate group, a thiol group, an alkenyl group, a vinyl ether group, an amino group, a fluoro group, or any combination thereof; R′ is a hydrogen atom or a hydrocarbon group having 1 to 4 carbon atoms, R″ is an alkyl or aryl group having 1-20 carbon atoms; and m, n, o is the molar percent of each resin unit in the resin, m+n+o=1.

3. A method of preparing a functional silicate resin comprising:
reacting (a) an MQ resin with (b) a monofunctional silane of the formula RR″₂Si(OR′) in the presence of (c) a catalytic amount of a base to form an MM′Q resin having a general formula:
((CH₃)₃SiO_{1/2})ₘ(RR″₂SiO_{1/2})ₙ(SiO_{4/2})ₒ
and, optionally, (d) an organic solvent,
wherein R is an organic functional group comprising an epoxy group, an acrylate group, a thiol group, an alkenyl group, a vinyl ether group, an amino group, a fluoro group, or any combination thereof; R′ is a hydrogen atom or a hydrocarbon group having 1 to 4 carbon atoms; each R″ is independently an alkyl or aryl group having 1-20 carbon atoms; and m, n, o is the molar percent of each resin unit in the resin, m+n+o=1.

4. The method according to claim 1, wherein the MQ resin has the formula:
((CH₃)₃SiO_{1/2})ₘ(SiO_{4/2})ₒ
wherein m, o is the molar percent of each resin unit in the resin, m+o=1, and the molar ratio of m/o is in the range of from about 0.1/1 to about 2/1.

5. The method according to claim 1, wherein the base includes potassium hydroxide, sodium hydroxide, cesium hydroxide, potassium methoxide, sodium methoxide, cesium methoxide, tetramethylammonium hydroxide, pyridine, methyl amine, imidazole, benzimidazole, histidine, phosphazene, or any combination thereof.

6. The method according to claim 1, wherein the organic solvent includes toluene, xylene, propylene glycol monomethyl ether acetate, 2-butanone, ethyl acetate, butyl acetate, acetonitrile, benzene, cyclohexane, dioxane, diethyl ether, tetrahydrofuran, hexane, or any combination thereof.

7. The method according to claim 1, wherein R is an organic functional group comprising an epoxy group, wherein the epoxy group is a 3-glycidoxypropyl group or a 2-(3,4-epoxycyclohexyl)ethyl group.

8. The method according to claim 1, wherein R is an organic functional group comprising an acrylate group, wherein the acrylate group contains the structural unit CH₂═CHR³—COO—, wherein R³ is hydrogen, an alkyl group or an aryl group.

9. The method according to claim 1, wherein R is an organic functional group comprising a thiol group, wherein the thiol group is
HS—Z—SiR″ₙ(OR′)₃₋ₙ
wherein Z is a hydrocarbon chain, including but not limited to, —CH₂—, —(CH₂)₂—, (CH₂)₃—, —(CHMe-CH₂CH₂)—, and —(CH₂)₄—; n=0, 1, or 2; R′ is a hydrogen atom or a hydrocarbon group having 1 to 4 carbon atoms; and each R″ is independently an alkyl or aryl group having 1-20 carbon atoms.

10. The method according to claim 1, wherein R is an organic functional group comprising an alkenyl group, wherein the alkenyl group is H₂C═CH—, H₂C═CHCH₂—, H₂C═C(CH₃)CH₂—, H₂C═CHCH₂CH₂—, H₂C═CHCH₂CH₂CH₂—, H₂C═CHCH₂CH₂CH₂CH₂—, or any combination thereof.

11. The method according to claim 1, wherein R is an organic functional group comprising a vinyl ether group.

12. The method according to claim 1, wherein R is an organic functional group comprising an amino group, wherein the amino group contains the structural unit R³N—, wherein R³ is hydrogen, an alkyl group, or an aryl group.

13. The method according to claim 1, wherein the reaction is conducted at temperature ranging from about 23° C. to about 150° C.

14. The method according to claim 1, wherein the amount of base in the functional silicate resin ranges from about 0.01 wt. % to about 1 wt. %.

15. The functional silicate resin prepared by the method of claim 1.

16. A functional silicate resin having a general formula:
((CH₃)₃SiO_{1/2})ₘ(RSiO_{3/2})ₙ(SiO_{4/2})ₒ
wherein R is an organic functional group comprising an epoxy group, an acrylate group, a thiol group, an alkenyl group, a vinyl ether group, an amino group, a fluoro group, or any combination thereof; and m, n, o is the molar percent of each resin unit in the resin, m+n+o=1.

17. The functional silicate resin of claim 16, wherein the functional silicate resin is
((CH₃)₃SiO_{1/2})ₘ[(R¹SiO_{3/2})ₓ(R²SiO_{3/2})_{y}]ₙ(SiO_{4/2})ₒ
wherein R¹ and R² are each independently an epoxy group, an acrylate group, an alkenyl group, a thiol group, a vinyl ether group, or any combination thereof; m, n, o is the molar percent of each resin unit in the resin, m+n+o=1; and x+y=n.

18. A functional silicate resin having a general formula:
((CH₃)₃SiO_{1/2})ₘ(RR″SiO_{2/2})ₙ(SiO_{4/2})ₒ
wherein R is an organic functional group comprising an epoxy group, an acrylate group, a thiol group, an alkenyl group, a vinyl ether group, an amino group, a fluoro group, or any combination thereof; R″ is an alkyl or aryl group having 1-20 carbon atoms; and m, n, o is the molar percent of each resin unit in the resin, m+n+o=1.

19. A functional silicate resin having a general formula:
((CH₃)₃SiO_{1/2})ₘ(RR″₂SiO1/2)ₙ(SiO_{4/2})ₒ
wherein R is an organic functional group comprising an epoxy group, an acrylate group, a thiol group, an alkenyl group, a vinyl ether group, an amino group, a fluoro group, or any combination thereof; each R″ is independently an alkyl or aryl group having 1-20 carbon atoms; and m, n, o is the molar percent of each resin unit in the resin, m+n+o=1.
